(19) United States
(12) Patent Application Publication
(10) Pub. No.: US 2012/0316288 A1
(43) Pub. Date: Dec. 13, 2012

(54) PROCESS OIL COMPOSITION

(76) Inventors: David Ernest Giles, Waterloo London (GB); David John Wedlock, Ince Chester Cheshire (GB)

(21) Appl. No.: 13/392,687

(22) PCT Filed: Aug. 26, 2010
(86) PCT No.: PCT/EP2010/062485

§ 371 Date: Apr. 30, 2012

(30) Foreign Application Priority Data
Aug. 28, 2009 (EP) 09168924.0

(51) Int. Cl. C08L 21/00; C10G 1/00

(52) U.S. Cl. 524/571; 208/14

(57) ABSTRACT

A process oil composition comprising: (i) from 50% to 99.9% by weight of de-asphalted cylinder oil (DACO); (ii) from 0.1% to 20% by weight of a Fischer-Tropsch derived base oil having a kinematic viscosity at 100° C. of not more than 4.0 mm²/s. The Fischer-Tropsch derived base oil is useful in a flux oil for de-asphalted cylinder oil. The process oil composition of the present invention is suitable for use as a process oil component in pneumatic tyres.

### FIELD OF THE INVENTION

The present invention relates to a process oil composition, particularly to a process oil composition comprising de-asphalted cylinder oil (DACO).

### BACKGROUND OF THE INVENTION

Process oil, also referred to as extender oil, is added to rubber compounds in the production process for tyres and other rubber goods to achieve an acceptable processability of the rubber compounds. The specific process oil used may also have an impact on certain performance characteristics of the final product, such as road adherence or grip properties, e.g. braking distance, but also other properties such as wear and endurance.

Many process oil compositions have been made with distillate aromatic extracts (DAE). Distillate aromatic extracts have very high aromatic contents, typically at least 70 wt %.

By the term “aromatic” it is meant a molecule composed primarily of carbon and hydrogen which comprises at least one ring which is composed of conjugated unsaturated carbon bonds, such as compounds containing a benzene moiety, polynuclear aromatics or polyaromatic compounds, i.e. compounds comprising more than one aromatic ring fused together, such as anthracene base moieties, are also included in this definition of aromatic. Such molecules may comprise sulphur as a heteroatom.

Distillate aromatic extracts are obtained as a by-product of the process of solvent extraction of vacuum distillates used as a raw material in the manufacture of lubricant base oils. Such distillate aromatic extracts generally contain high concentrations of polynuclear aromatics, typically from 10 to 25 wt %, as measured by IP 346 method.

Certain polynuclear aromatics (PNA), which are also known as higher aromatic rings, polycyclic aromatics (PCA) or polyaromatic hydrocarbons (PAH), are known carcinogens.

Distillate aromatic extracts are classified as “carcinogenic” according to the European legislation (EU Substance Directive 67/548/EEC) and must be labelled with the risk phrase “R45” (may cause cancer) and the label “T” (toxic, skull and crossbones) in Europe.

Accordingly, process oil compositions comprising 0.1 wt % or more of distillate aromatic extracts must also be labelled with the risk phrase “R45” (may cause cancer) and the label “T” (toxic, skull and crossbones) in Europe due to the levels of polynuclear aromatics and in particular polyaromatic hydrocarbons therein.

From the viewpoint of health, safety and environmental impact, it is therefore highly desirable to use alternatives to distillate aromatic extracts as blending components in process oil compositions. Indeed, it is the intention of the tyre industry to phase-out use of highly aromatic oils in order to comply with EC Directive 2005/69/EC restricting the marketing and use of certain polycyclic aromatic hydrocarbons in extender oils used in tyre production. The Directive specifies that tyres produced after 1 Jan. 2010 have to comply with requirements of the Directive.

It is important that whatever is used as an alternative to highly aromatic oils in process oils must be capable of being easily processed and must not negatively impact the performance and safety characteristics of the final product.

De-asphalted cylinder oil (DACO) may be used as a blending component in process oil compositions as an alternative to distillate aromatic extracts. In particular, de-asphalted cylinder oil contains much lower levels of carcinogenic polynuclear aromatics than distillate aromatic extracts and therefore de-asphalted cylinder oil (DACO) is more desirable than distillate aromatic extracts (DAE) from a health, safety and environmental impact viewpoint. DACO also has a high flashpoint which is advantageous from a safety point of view.

WO2008/046898 discloses an electrical oil composition comprising DACO and one or more base oils each having a kinematic viscosity at 100° C. of not more than 4 mm²/s. The one or more base oils are selected from one or more mineral-derived paraffinic oils, one or more mineral-derived naphthenic oils, one or more Fischer-Tropsch derived base oils and mixtures thereof. Example 5 discloses an electrical oil composition comprising 99% Gas to Liquids base oil and 1% DACO. However, there is no disclosure in the document of the use of a Fischer-Tropsch derived base oil as a flux oil for DACO.

WO2007/003617 discloses a process to prepare an oil blend comprising (i) de-asphalting a mineral-derived vacuum residue to obtained a de-asphalted oil, (ii) optionally extracting from the de-asphalted oil an aromatic extract by solvent extraction process; and (iii) blending the de-asphalted oil obtained in (i) or the aromatic extract obtained in (ii) with a paraffinic base oil. Preferably the paraffinic base oil has a viscosity at 100° C. of from 8 to 25 mm²/s. Example G contains 80% DACO and 20% GTL base oil, wherein the GTL base oil has a kinematic viscosity at 100° C. of 19 mm²/s. There is no disclosure in this document of the use of a low viscosity GTL base oil as a flux oil for DACO.

While being advantageous from a safety and environmental point of view, DACO unfortunately suffers from the disadvantage of being highly viscous and therefore it is more difficult to process than DAE. Due to its high viscosity DACO may need to be pumped at higher pressure than DAE or heavier duty pumps may need to be used, for example, to transfer DACO from a cargo ship to point of use.

In order for DACO to become an economically viable option for use in a process oil, it is therefore necessary to reduce the viscosity of DACO, such that it can be pumped and processed more easily. However, it is important from a safety point of view that whatever is done to modify the flow properties of DACO does not lower the flashpoint significantly or contribute to additional polynuclear aromatics.

It has now surprisingly been found by the present inventors that a Fischer-Tropsch derived base oil having a kinematic viscosity at 100° C. of not more than 4.0 mm²/s can be used as a flux (flow modifying) oil for DACO without significantly lowering the flashpoint of DACO and without contributing to additional polynuclear aromatics content.

### SUMMARY OF THE INVENTION

According to the present invention there is provided a process oil composition comprising:

(i) from 50% to 99.9% by weight of de-asphalted cylinder oil (DACO);
(ii) from 0.1% to 20% by weight of a Fischer-Tropsch derived base oil having a kinematic viscosity at 100° C. of not more than 4.0 mm²/s.

It has surprisingly been found that a Fischer-Tropsch derived base oil having a kinematic viscosity at 100° C. of not more than 4.0 mm²/s acts as a flux oil for DACO. In particular, the Fischer-Tropsch derived base oil lowers the viscosity of DACO, while maintaining the flash point of the DACO at an acceptable level. In addition, the Fischer-Tropsch derived base oil does not contribute to additional polynuclear aromatics content.

Hence according to another aspect of the present invention there is provided the use of a Fischer-Tropsch derived base oil as a flux oil for de-asphalted cylinder oil in a process oil composition comprising (i) from 50% to 99.9% by weight of de-asphalted cylinder oil (DACO) and (ii) from 0.1% to 20% by weight of a Fischer-Tropsch derived base oil, wherein the Fischer-Tropsch derived base oil has a kinematic viscosity at 100° C. of not more than 4.0 mm²/s.

According to yet a further aspect of the present invention there is provided the use of the process oil composition described herein in pneumatic tyres.

According to yet a further aspect of the present invention there is provided a pneumatic tyre comprising a vulcanizable rubber component, wherein the vulcanizable rubber component comprises a process oil composition as described herein.

### DETAILED DESCRIPTION OF THE INVENTION

The process oil composition of the present invention comprises, as an essential ingredient, a de-asphalted cylinder oil (DACO).

The de-asphalted cylinder oil (DACO) used in the present invention may be prepared by de-asphalting a mineral-derived vacuum residue to obtain a de-asphalted oil (DAO), solvent-extracting the de-asphalted oil and obtaining the de-asphalted cylinder oil (DACO) extract.

The de-asphalted oil (DAO) used is defined as the product of a de-asphalting process step wherein asphalt is removed from a reduced crude petroleum feed or from the residue, bottom fraction, of a vacuum distillation of a crude petroleum feed (hereinafter referred to as “mineral-derived vacuum residues”).

The de-asphalting process utilises a light hydrocarbon liquid solvent, for example propane, for asphalt compounds.

De-asphalting processes are well known and, for example, are described in “Lubricant base oil and wax processing”, Avilino Sequeira, Jr., Marcel Dekker, Inc., New York, 1994, ISBN 0-8247-9256-4, pages 53-80.

The de-asphalted oil undergoes solvent extraction, wherein residual aromatic extract known as de-asphalted cylinder oil (DACO) is removed therefrom.

Examples of solvent extraction processes that may be conveniently used include furfural or NMP solvent extraction processes or other solvent extraction processes, for example, as described in Chapter 5 of “Lubricant base oil and wax processing”, Avilino Sequeira, Jr., Marcel Dekker, Inc., New York, 1994, ISBN 0-8247-9256-4.

The benzo[a]pyrene content and 8 PAH content may be measured in the de-asphalted cylinder oil by GC/MS analysis. For example, this technique is commercially available at Biochemishes Institut für Umweltcarcinogene (Prof. Dr. Gernot Grimmer-Stiftung), Lurup 4, D-22927 Grosshansdorf, Germany.

The amount of polyaromatic hydrocarbons subsequently present in the de-asphalted cylinder oil may be controlled during isolation of the mineral-derived vacuum residue by appropriate selection of the cut width of the highest boiling distillate fraction.

The de-asphalted cylinder oil preferably has a sulphur content in the range of from 0.5 to 5 wt %, more preferably in the range of from 3 to 4.5 wt %, as measured by ISO 14596, based on the total weight of the de-asphalted cylinder oil.

The kinematic viscosity at 100° C. of the de-asphalted cylinder oil is typically less than 100 mm²/s, preferably in the range of from 35 to 90 mm²/s, as measured in accordance with ISO 3104.

The flash point of the de-asphalted cylinder oil is preferably about 250° C., more preferably above 280° C. and most preferably about 290° C., as measured by the Cleveland Open Cup (COC) method, ISO 2592.

The DMSO extractable content of the de-asphalted cylinder oil used herein is typically greater than 3% m/m, more typically greater than 5% m/m, as determined according to the IP346 test method specified by the Institute of Petroleum. The Mutagenicity Index (MI) of the de-asphalted cylinder oil used herein is preferably less than 1 as determined by the Modified Ames test method (according to ASTM E1687).

The de-asphalted cylinder oil is preferably present in the process oil composition of the present invention in an amount in the range of from 50 to 99.9 wt %, more preferably in the range of from 60 to 98 wt %, and most preferably in the range of from 90 to 95 wt %, based on the total weight of the process oil composition.

A second essential component of the process oil composition herein is a Fischer-Tropsch derived base oil having a kinematic viscosity at 100° C. of not more than 4 mm²/s.

The term “Fischer-Tropsch derived” as used herein means that a material is, or derives from, a synthesis product of a Fischer-Tropsch condensation process. A Fischer-Tropsch derived product may also be referred to as a “GTL (Gas-to-Liquid)” product.

The Fischer-Tropsch derived base oil for use herein preferably has a kinematic viscosity at 100° C. (according to ASTM D445) of not more than 3.5, more preferably not more than 3 mm²/s. The Fischer-Tropsch derived base oil preferably has a kinematic viscosity of at least 2 mm²/s, more preferably at least 2.3 mm²/s, and even more preferably at least 2.5 mm²/s.

The Fischer-Tropsch condensation process is a reaction which converts carbon monoxide and hydrogen into longer chain, usually paraffinic, hydrocarbons:

n(CO+2H₂)═(—CH₂—)ₙ+nH₂O+heat,

in the presence of an appropriate catalyst and typically at elevated temperatures (e.g. 125 to 300° C., preferably 175 to 250° C.) and/or pressures (e.g. 5 to 100 bar, preferably 12 to 50 bar). Hydrogen:carbon monoxide ratios other than 2:1 may be employed if desired.

The carbon monoxide and hydrogen may themselves be derived from organic or inorganic, natural or synthetic sources, typically either from natural gas or from organically derived methane. In general the gases which are converted into liquid fuel components using Fischer-Tropsch processes can include natural gas (methane), LPG (e.g. propane or butane), “condensates” such as ethane, synthesis gas (CO/hydrogen) and gaseous products derived from coal, biomass and other hydrocarbons.

The Fischer-Tropsch process can be used to prepare a range of hydrocarbon fuels, including LPG, naphtha, kerosene and gas oil fractions. Of these, the gas oils have been used as, and in, automotive diesel fuel compositions, typically in blends with petroleum derived gas oils. The heavier fractions can yield, following hydroprocessing and vacuum distillation, a series of base oils having different distillation properties and viscosities, which are useful as lubricating base oil stocks.

Hydrocarbon products may be obtained directly from the Fischer-Tropsch reaction, or indirectly for instance by fractionation of Fischer-Tropsch synthesis products or from hydrotreated Fischer-Tropsch synthesis products. Hydrotreatment can involve hydrocracking to adjust the boiling range and/or hydroisomerisation which can improve cold flow properties by increasing the proportion of branched paraffins. Other post-synthesis treatments, such as polymerisation, alkylation, distillation, cracking-decarboxylation, isomerisation and hydroreforming, may be employed to modify the properties of Fischer-Tropsch condensation products.

Typical catalysts for the Fischer-Tropsch synthesis of paraffinic hydrocarbons comprise, as the catalytically active component, a metal from Group VIII of the periodic table, in particular ruthenium, iron, cobalt or nickel. Suitable such catalysts are described for instance in EP-A-0583836 (pages 3 and 4).

An example of a Fischer-Tropsch based process is the SMDS (Shell Middle Distillate Synthesis) described in “The Shell Middle Distillate Synthesis Process”, van der Burgt et al, paper delivered at the 5^{th} Synfuels Worldwide Symposium, Washington D.C., November 1985; see also the November 1989 publication of the same title from Shell International Petroleum Company Ltd, London, UK. This process (also sometimes referred to as the Shell “Gas-To-Liquids” or “GTL” technology) produces middle distillate range products by conversion of a natural gas (primarily methane) derived synthesis gas into a heavy long chain hydrocarbon (paraffin) wax which can then be hydroconverted and fractionated to produce liquid transport fuels such as the gas oils useable in diesel fuel compositions. Base oils, including heavy base oils, may also be produced by such a process. A version of the SMDS process, utilising a fixed bed reactor for the catalytic conversion step, is currently in use in Bintulu, Malaysia and its gas oil products have been blended with petroleum derived gas oils in commercially available automotive fuels.

By virtue of the Fischer-Tropsch process, a Fischer-Tropsch derived base oil has essentially no, or undetectable levels of, sulphur and nitrogen. Compounds containing these heteroatoms tend to act as poisons for Fischer-Tropsch catalysts and are therefore removed from the synthesis gas feed. This can bring additional benefits to compositions comprising Fischer-Tropsch derived base oils in accordance with the present invention.

Further, the Fischer-Tropsch process as usually operated produces no or virtually no aromatic components. The aromatics content of a Fischer-Tropsch derived base oil component, suitably determined by ASTM D-4629, will typically be below 1 wt %, preferably below 0.5 wt % and more preferably below 0.1 wt % on a molecular (as opposed to atomic) basis.

Generally speaking, Fischer-Tropsch derived hydrocarbon products have relatively low levels of polar components, in particular polar surfactants, for instance compared to petroleum derived hydrocarbons. This may contribute to improved antifoaming and dehazing performance. Such polar components may include for example oxygenates, and sulphur and nitrogen containing compounds. A low level of sulphur in a Fischer-Tropsch derived hydrocarbon is generally indicative of low levels of both oxygenates and nitrogen containing compounds, since all are removed by the same treatment processes.

The Fischer-Tropsch derived base oil is present in the process oil composition herein at a level of at least 0.1%, preferably at least 5%, more preferably at least 10%, by weight of the process oil composition.

The Fischer-Tropsch derived base oil is preferably present in the process oil composition herein at a level of at most 20%, more preferably at most 15% and even more preferably at most 10%, by weight of the process oil composition.

Suitable Fischer-Tropsch derived base oils that may be conveniently used as base oil in the process oil composition of the present invention are those as for example disclosed in EP 0 776 959, EP 0 668 342, WO 97/21788, WO 00/15736, WO 00/14188, WO 00/14187, WO 00/14183, WO 00/14179, WO 00/08115, WO 99/41332, EP 1 029 029, WO 01/18156, WO 01/57166 and WO04/07647.

A particularly preferred Fischer-Tropsch derived base oil for use herein is GTL 3.

The Fischer-Tropsch derived base oil is useful herein as a flux oil for de-asphalted cylinder oil. As used herein the term “flux oil” means flow modifying oil.

The process oil composition of the present invention can advantageously be used as a process oil component in pneumatic tyres. Hence according to another aspect of the present invention there is provided a pneumatic tyre comprising a vulcanizable rubber component wherein the vulcanizable rubber component comprises a process oil as described herein.

The present invention will now be described by reference to the following Examples:

### Examples 1-3 and Comparative Examples A-J

All the Examples and Comparative Examples contained the same de-asphalted cylinder oil (DACO). The de-asphalted cylinder oil had a kinematic viscosity at 100° C. of 47.02 mm²/s as measured by IP 71 and a Flash Point 272° C. as measured by IP 34/ASTM D93. The DMSO extractable content of the DACO was determined according to the IP346 test method specified by the Institute of Petroleum. Two measurements of the DMSO extractable content were made and were found to be 6.7% m/m and 7.0% m/m, respectively. The Mutagenicity Index (MI) of the DACO was less than 1 as determined by the Modified Ames test method (according to ASTM E1687).

Examples 1 to 3 (according to the present invention) were prepared by blending de-asphalted cylinder oil with a Fischer-Tropsch derived base oil in the levels set out in Table 2 below. The Fischer-Tropsch base oil used in Examples 1 to 3 was prepared according to the method described in WO2009/071608. The physical properties of the Fischer-Tropsch derived base oil (denoted as “GTL 3”) used in Examples 1 to 3 are shown in Table 1 below.

Comparative Example A consisted of 100% DACO.

Comparative Examples B, C and D were prepared by blending de-asphalted cylinder oil with a catalytically de-waxed gas oil in the levels set out in Table 2 below. The catalytically dewaxed gas oil used in Comparative Examples B, C and D was prepared according to the method described in WO2009/071608. The physical properties of the catalytically dewaxed gas oil used in Comparative Examples B, C and D (denoted as “CDW Gasoil”) are shown in Table 1 below.

Comparative Examples E, F and G were prepared by blending de-asphalted cylinder oil with a solvent neutral mineral derived base oil (commercially available from AGIP Oil Company, Italy under the grade description SN90) in the levels set out in Table 2 below. The physical properties of SN90 used in Comparative Example 2 (denoted as SN90) are shown in Table 1 below.

Comparative Examples H, I and J were prepared by blending de-asphalted cylinder oil with a Fischer-Tropsch derived base oil different to that used in Example 1. The Fischer-Tropsch base oil used in Comparative Example 3 was prepared according to the method described in U.S. Pat. No. 7,354,508. The physical properties of the Fischer-Tropsch derived base oil used in Comparative Example 3 (referred to as “GTL 8”) are shown in Table 1 below.

TABLE 1

| | GTL 3 | GTL 8 | SN90 | CDW Gas Oil |
|---|---|---|---|---|
| Vₖ 40 (mm²/s)¹ | 9.402 | 43.213 | 15.73 | 2.265 |
| Vₖ 100 (mm²/s)¹ | 2.662 | 7.58 | 3.536 | 0.9967 |
| VI² | 123 | 144 | 103 | n/a⁴ |
| Flash Point | 190.5 | 244.0 | 206 | 78 |
| (° C.)³ | | | | |
| TPC Content % | 0.7 | 0.5 | 21.6 | 0.6 |
| weight | | | | |

¹As measured by ASTM D445
²As measured by ASTM D2270
³As measured by ASTM D93
⁴Not applicable
⁵As measured by IP-368

TABLE 2

| | Example: | | | | | | | | | | | | |
|---|---|---|---|---|---|---|---|---|---|---|---|---|---|
| | A* | B* | C* | D* | 1 | 2 | 3 | E* | F* | G* | H* | I* | J* |
| | (wt %) | (wt %) | (wt %) | (wt %) | (wt %) | (wt %) | (wt %) | (wt %) | (wt %) | (wt %) | (wt %) | (wt %) | (wt %) |
| DACO | 100 | 97 | 95 | 90 | 97 | 95 | 90 | 97 | 95 | 90 | 97 | 95 | 90 |
| CDW Gas | 0 | 3 | 5 | 10 | 0 | 0 | 0 | 0 | 0 | 0 | 0 | 0 | 0 |
| Oil | | | | | | | | | | | | | |
| GTL 3 | 0 | 0 | 0 | 0 | 3 | 5 | 10 | 0 | 0 | 0 | 0 | 0 | 0 |
| SN 90 | 0 | 0 | 0 | 0 | 0 | 0 | 0 | 3 | 5 | 10 | 0 | 0 | 0 |
| GTL 8 | 0 | 0 | 0 | 0 | 0 | 0 | 0 | 0 | 0 | 0 | 3 | 5 | 10 |
| Results: | | | | | | | | | | | | | |
| Vₖ 100¹ | 47.02 | 36.93 | 31.34 | 22.4 | 40.53 | 36.66 | 28.85 | 41.21 | 38.3 | 31.72 | 42.46 | 39.93 | 34.89 |
| Flashpoint | 272 | 136.5 | 122.5 | 102.5 | 238 | 236 | 222 | 250 | 236 | 228 | 251 | 255 | 267 |
| ° C.² | | | | | | | | | | | | | |

*Comparative Examples
¹As measured by ASTM D445
²As measured by ASTM D93

### Discussion

As can be seen from the results in Table 2, GTL 3 gave the best results in terms of lowering the viscosity of the DACO while not lowering the flashpoint to an unacceptable level. In addition, GTL 3 makes no contribution to the polycyclic aromatics content of the composition.

1. A process oil composition comprising:
i) from 50% to 99.9% by weight of de-asphalted cylinder oil (DACO);
ii) from 0.1% to 20% by weight of a Fischer-Tropsch derived base oil having a kinematic viscosity at 100° C. of not more than 4.0 mm²/s.

2. A process oil composition according to claim 1 wherein the Fischer-Tropsch derived base oil has a kinematic viscosity at 100° C. of not more than 3.5 mm²/s.

3. A process oil composition according to claim 1 wherein the Fischer-Tropsch derived base oil has a kinematic viscosity at 100° C. of not more than 3 mm²/s.

4. A process oil composition according to claim 1 wherein the Fischer-Tropsch derived base oil has a flashpoint of not less than 150° C.

5. A process oil composition according to claim 1 comprising from 5% to 20% by weight of the Fischer-Tropsch derived base oil.

6. A process oil composition according to claim 1 comprising from 5% to 15% by weight of the Fischer-Tropsch derived base oil.

7. A process oil composition according to claim 1 wherein the de-asphalted cylinder oil has a viscosity of not less than 40 mm²/s.

8. A process oil composition according to claim 1 wherein the de-asphalted cylinder oil has a flashpoint of not less than 290° C.

9. A process oil composition according to claim 1 wherein the process oil composition has a kinematic viscosity at 100° C. of at most 42 mm²/s.

10. A process oil composition according to claim 1 wherein the process oil composition has a flash point of more than 200° C.

11. (canceled)

12. (canceled)

13. A pneumatic tyre comprising a vulcanizable rubber composition wherein the vulcanizable rubber composition comprises a process oil according to claim 1.

14. A process oil composition according to claim 1 wherein the Fischer-Tropsch derived base oil has a kinematic viscosity at 100° C. of not more than 3 mm²/s and a flashpoint of not less than 150° C.

15. A process oil composition according to claim 14 comprising from 5% to 20% by weight of the Fischer-Tropsch derived base oil.

16. A process oil composition according to claim 14 comprising from 5% to 15% by weight of the Fischer-Tropsch derived base oil.

17. A process oil composition according to claim 14 wherein the de-asphalted cylinder oil has a viscosity of not less than 40 mm²/s and a flashpoint of not less than 290° C.

18. A process oil composition according to claim 19 wherein the process oil composition has a kinematic viscosity at 100° C. of at most 42 mm²/s.

19. A process oil composition according to claim 19 wherein the process oil composition has a flash point of more than 200° C.
